(19) United States
(12) Patent Application Publication
(10) Pub. No.: US 2026/0337947 A1
(43) Pub. Date: Oct. 29, 2026

(54) Plug-Level

(71) Applicant: Crowne Tools LLC, Dallas, TX (US)

(72) Inventor: Andrew Eylander, Carlsbad, CA (US)

(21) Appl. No.: 19/550,135

(22) Filed: Feb. 25, 2026

Related U.S. Application Data
(60) Provisional application No. 63/795,930, filed on Apr. 28, 2025.

(51) Int. Cl. E03F 5/04; G01C 9/36

(52) U.S. Cl. CPC E03F 5/041; E03F 5/0408; G01C 9/36

(57) ABSTRACT

A plug level for a bonded flange-style shower drain base includes an insert that defines a central axis; and a level mounted to the insert along the central axis.

### CROSS REFERENCE TO RELATED APPLICATIONS

This application claims the priority of U.S. Provisional Patent Application No. 63/795,930 filed Apr. 28, 2025.

### BACKGROUND

The present disclosure relates to tile tools used during tile installation, and more specifically to a leveling and debris-blocking insert for bonded flange-style shower drain bases.

Bonded flange-style shower drain bases are specialized plumbing components designed to connect shower drains (particularly linear or square types) to the drain pipe, often featuring adjustable heights and integrated waterproofing capabilities. These bases act as an adapter between the drain body and the 2-inch or 3-inch waste pipe, commonly used in modern tiled showers. Bonded flange-style shower drain bases must be carefully leveled during installation to ensure proper drainage and long-term performance. This process is often carried out by repeatedly checking with a torpedo level, a method prone to inconsistencies and time delays.

In addition, during installation of the mud bed (e.g., deck mud or dry pack), debris frequently falls into the open drain, even when a traditional drain plug is used. This debris can be difficult to remove and may cause long-term drainage problems or clogging.

This background section is intended to introduce the reader to various aspects of art that may be related to various aspects of the present disclosure, which are described and/or claimed below. This discussion is believed to assist the reader with background information to facilitate a better understanding of the various aspects of the present disclosure. Accordingly, it should be understood that these statements are to be read in this light, and not as admissions of prior art.

### SUMMARY

A plug level for a bonded flange-style shower drain base according to one disclosed non-limiting embodiment of the present disclosure includes an insert that defines a central axis; and a level mounted to the insert along the central axis.

A further embodiment of any of the foregoing embodiments of the present disclosure includes the insert is circular.

A further embodiment of any of the foregoing embodiments of the present disclosure includes the insert is sized to provide an interference fit within the bonded flange-style shower drain base.

A further embodiment of any of the foregoing embodiments of the present disclosure includes the level is a bubble level.

A further embodiment of any of the foregoing embodiments of the present disclosure includes the level is a 360 degree level.

A further embodiment of any of the foregoing embodiments of the present disclosure includes the level a 25mm circular bubble level, seated flush in a recessed cavity of the insert.

A further embodiment of any of the foregoing embodiments of the present disclosure includes a keyhole offset from the central axis.

A further embodiment of any of the foregoing embodiments of the present disclosure includes the keyhole is a slot.

A method of installing a bonded flange-style shower drain base according to one disclosed non-limiting embodiment of the present disclosure includes inserting a plug level within an opening in the bonded flange-style shower drain base; installing the bonded flange-style shower drain base using the plug level to level the bonded flange-style shower drain base; and removing the plug level.

A further embodiment of any of the foregoing embodiments of the present disclosure includes the plug level is interference fit within the opening in the bonded flange-style shower drain base.

A further embodiment of any of the foregoing embodiments of the present disclosure includes installing the bonded flange-style shower drain base includes installing the mud bed.

A further embodiment of any of the foregoing embodiments of the present disclosure includes removing the plug level inserting a tool in a keyhole of the plug level to pull out the plug level.

The foregoing features and elements may be combined in various combinations without exclusivity, unless expressly indicated otherwise. These features and elements as well as the operation thereof will become more apparent in light of the following description and the accompanying drawings. It should be appreciated that however the following description and drawings are intended to be exemplary in nature and non-limiting.

### BRIEF DESCRIPTION OF THE DRAWINGS

Various features will become apparent to those skilled in the art from the following detailed description of the disclosed non-limiting embodiment. The drawings that accompany the detailed description can be briefly described as follows:

FIG. 1 is an exploded view of a plug level that fits into a bonded flange-style shower drain base according to one disclosed non-limiting embodiment.

FIG. 2 is a top perspective view of the plug level.

FIG. 3 is a bottom perspective view of the plug level.

### DETAILED DESCRIPTION

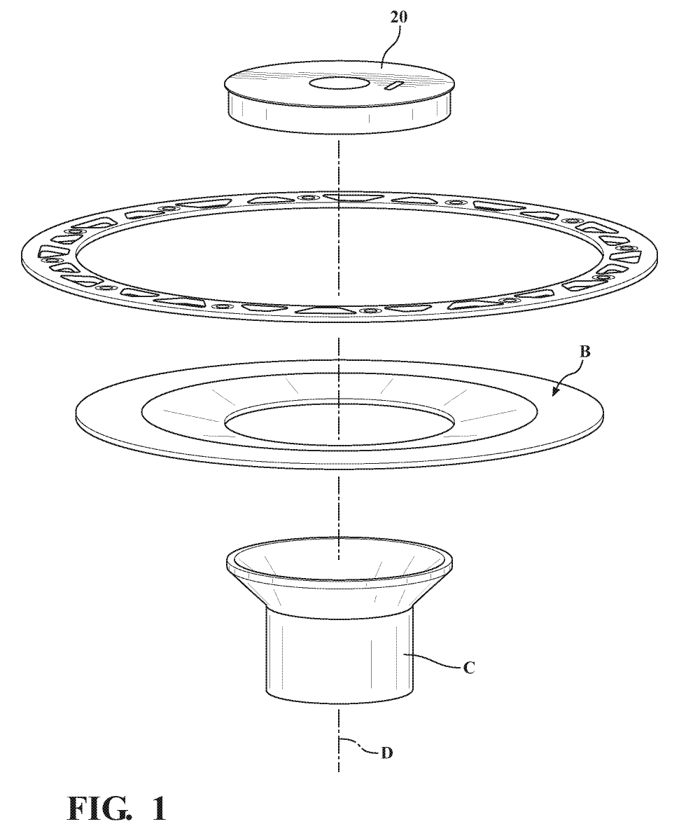

FIG. 1 schematically illustrates a plug level 20 that fits into a bonded flange-style shower drain base B, such as those produced by Schluter Systems® of Plattsburgh, New York., FLOWFx® of Cedar City, Utah, and others that remain in place during the placement and shaping of the mud bed.

Bonded flange-style drain bases B are designed for modern, waterproof shower systems that use sheet or liquid-applied membranes rather than traditional, thick-bed pan liners. These systems feature a large flange, usually with a fabric collar or a specialized surface, to which the waterproofing membrane is directly bonded using thin-set mortar, mud, or sealant to provide a secure, watertight connection atop of the drain assembly.

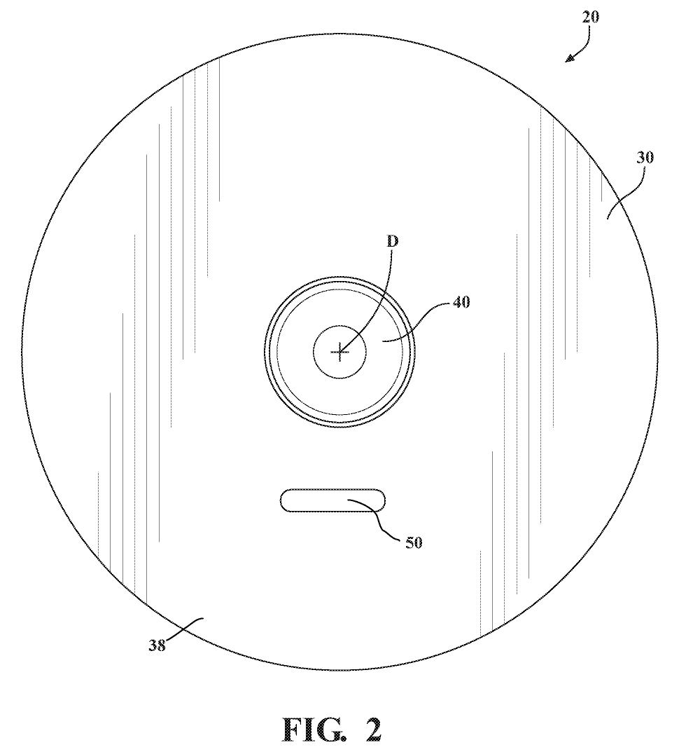

With reference to FIG. 2, the plug level 20 generally includes an insert 30 that seals the drain opening C (FIG. 1), and a level 40 along a central axis D that continuously indicates the level state of the drain base B throughout the installation process. The plug level 20 may remain in place throughout the entire installation of the mud shower base, serving both as a protective plug and a built-in leveling tool.

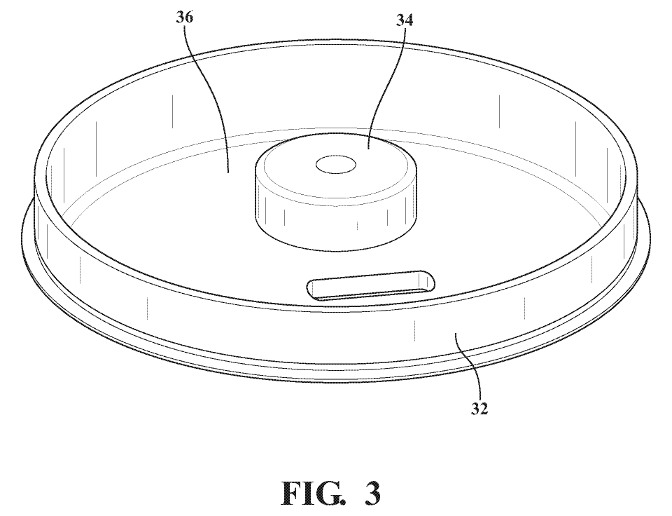

The insert 30 outer periphery 32 (FIG. 3) is sized to interference fit into the bonded flange-style shower drain base B to prevent debris from entering the plumbing during installation. In embodiments, the insert 30 may be manufactured of plastic such as ABS plastic to closely fit within a collar C of the bonded flange-style shower drain base B. Although illustrated in the disclosed embodiment as circular, the insert 30 may be of various shapes such as rectilinear to closely interface with the drain opening C.

The insert 30 may further include a recessed portion 34 (FIG. 3) with respect to a flanged portion 36 about the central axis D to receive the level 40. The level 40 may fit flush within the recessed portion 34 to continuously indicate the level state of the drain base B throughout the installation process. The level 40, in embodiments, may be a 25mm circular bubble level which allows installers to quickly assess and maintain level in all directions without external tools. Alternatively, the level 40 may be digital or electronic.

The insert 30 may further include a relatively small keyhole 50 such as a slot or other recess in a top surface 38 to facilitate extraction of the plug level 20 via a standard tool such as a pick, flat-head screwdriver, or utility knife.

The plug level 20 is designed to remain in place throughout the entire installation of the mud shower base, serving both as a protective plug and a built-in leveling tool.

Although the different non-limiting embodiments have specific illustrated components, the embodiments of this invention are not limited to those particular combinations. It is possible to use some of the components or features from any of the non-limiting embodiments in combination with features or components from any of the other non-limiting embodiments.

The foregoing description is exemplary rather than defined by the limitations within. Various non-limiting embodiments are disclosed herein, however, one of ordinary skill in the art would recognize that various modifications and variations in light of the above teachings will fall within the scope of the appended claims. It is therefore to be appreciated that within the scope of the appended claims, the disclosure may be practiced other than as specifically described. For that reason the appended claims should be studied to determine true scope and content.

What is claimed:

1. A plug level for a bonded flange-style shower drain base, comprising:
an insert that defines a central axis; and
a level mounted to the insert along the central axis.

2. The plug level as recited in claim 1, wherein the insert is circular.

3. The plug level as recited in claim 1, wherein the insert is sized to provide an interference fit within the bonded flange-style shower drain base.

4. The plug level as recited in claim 1, wherein the level is a bubble level.

5. The plug level as recited in claim 1, wherein the level is a 360 degree level.

6. The plug level as recited in claim 1, wherein the level a 25mm circular bubble level, seated flush in a recessed cavity of the insert.

7. The plug level as recited in claim 1, wherein the insert comprises a keyhole offset from the central axis.

8. The plug level as recited in claim 7, wherein the keyhole is a slot.

9. A method of installing a bonded flange-style shower drain base, comprising:
inserting a plug level within an opening in the bonded flange-style shower drain base;
installing the bonded flange-style shower drain base using the plug level to level the bonded flange-style shower drain base; and
removing the plug level.

10. The method as recited in claim 9, wherein the plug level is interference fit within the opening in the bonded flange-style shower drain base.

11. The method as recited in claim 9, wherein installing the bonded flange-style shower drain base comprises installing the mud bed.

12. The method as recited in claim 9, wherein removing the plug level inserting a tool in a keyhole of the plug level to pull out the plug level.
